(19) United States
(12) Patent Application Publication
(10) Pub. No.: US 2010/0000041 A1
(43) Pub. Date: Jan. 7, 2010

(54) WINDSCREEN WIPER DEVICE

(76) Inventor: Xavier Boland, Arlon (BE)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/297,945

(22) PCT Filed: Apr. 5, 2007
(86) PCT No.: PCT/EP2007/053389

§ 371 Date: Jun. 3, 2009

(30) Foreign Application Priority Data
Apr. 21, 2006 (EP) 06112901.1

(51) Int. Cl. B60S 1/40

(52) U.S. Cl. 15/250.32

(57) ABSTRACT

A windscreen wiper device comprising an elastic, elongated carrier element, as well as an elongated wiper blade of a flexible material, which can be placed in abutment with a windscreen to be wiped, which wiper blade includes opposing longitudinal grooves on its longitudinal sides, in which grooves spaced-apart longitudinal strips of the carrier element are disposed, wherein neighbouring ends of the longitudinal strips are interconnected by a respective connecting piece, which windscreen wiper device comprises a connecting device for an oscillating arm, wherein the oscillating arm is pivotally connected to the connecting device about a pivot axis near one end, with the interposition of a joint part, with the special feature that the joint part is detachable connected to the connecting device by engaging protrusions of the connecting device, at the location of the pivot axis, in recesses provided in the joint part, and wherein the protrusions are provided with co-axial through holes.

The present invention relates to a windscreen wiper device comprising an elastic, elongated carrier element, as well as an elongated wiper blade of a flexible material, which can be placed in abutment with a windscreen to be wiped, which wiper blade includes opposing longitudinal grooves on its longitudinal sides, in which grooves spaced-apart longitudinal strips of the carrier element are disposed, wherein neighbouring ends of said longitudinal strips are interconnected by a respective connecting piece, which windscreen wiper device comprises a connecting device for an oscillating arm, wherein said oscillating arm is pivotally connected to said connecting device about a pivot axis near one end, with the interposition of a joint part.

Such a windscreen wiper device is known from European patent publication no. 1 403 156 of the same Applicant. This prior art windscreen wiper device is designed as a “yokeless” wiper device, wherein no use is made of several yokes pivotally connected to each other, but wherein the wiper blade is biassed by the carrier element, as a result of which it exhibits a specific curvature. In this prior art windscreen wiper device the joint part comprises at least one resilient tongue engaging in a correspondingly shaped hole provided in the oscillating arm, wherein the resilient tongue is rotatable along an hinge axis between an outward position retaining the wiper blade onto the oscillating arm and an inward position releasing the wiper blade from the oscillating arm. In order to connect the wiper blade onto the oscillating arm, the resilient tongue is initially pushed in against a spring force—as if it were a push button—and then allowed to spring back into the hole provided in the oscillating arm, thus snapping, that is clipping the resilient tongue into the hole. By subsequently pushing in again the resilient tongue against the spring force, the wiper blade may be released from the oscillating arm.

The object of the invention is to provide a improved windscreen wiper device.

In order to accomplish that objective, a windscreen wiper device of the type referred to in the introduction is characterized according to the invention in that said joint part is detachably connected to said connecting device by engaging protrusions of said connecting device, at the location of said pivot axis, in recesses provided in said joint part, and wherein said protrusions are provided with co-axial through holes. Said connecting device acts as a base part, wherein the connecting device is preferably fixedly connected to the longitudinal strips through a welding, brazing (“soldering”), glueing or clamping operation. The essence of the present invention is that said connecting device is a universal connection part for each type of interconnection between the wiper blade and the oscillating arm. A different type of said joint part to be connected to said connecting device may be used for each different type of interconnection between the wiper blade and the oscillating arm. The advantage achieved by the invention is that a unit consisting of said wiper blade and said connecting device connected to said longitudinal strips can be manufactured for each and every type of interconnection between said wiper blade and said oscillating arm, while only a relatively cheap and easy to manufacture joint part to be connected to said connecting has to correspond with a specific type of interconnection between said wiper blade and said oscillating arm. Thus, a universal connection between the wiper blade and the oscillating arm is obtained, so that car drivers are given the possibility to buy also non-original cheap wiper blades fitting the original oscillating arms on their cars. Said joint part may be connected to said connecting device through a snapping/clipping operation.

It is noted that said protrusions that function as bearing surfaces are spaced far apart, so that the forces exerted thereon will be relatively low.

In one preferred embodiment of a windscreen wiper device in accordance with the invention said joint part has an at least substantially U-shaped cross-section at the location of its connection to said connecting device, wherein said joint part in each leg of said U-shaped cross-section is provided with a recess provided coaxially with said pivot axis. More in particular, the protrusions extend outwards on either side of said connecting device, wherein the protrusions are at least substantially cylindrical. In the alternative, said protrusions are at least substantially spherical or frusto-conical.

In another preferred embodiment of a windscreen wiper device according to the invention said joint part is pivotally connected to said connecting device, wherein said protrusions of said connecting device pivotally engage in said recesses of said joint part, wherein said joint part comprises at least one resilient tongue engaging in a correspondingly shaped hole provided in said oscillating arm, wherein said resilient tongue is rotatable along a hinge axis between an outward position retaining said wiper blade onto said oscillating arm and an inward position releasing said wiper blade from said oscillating arm. Said hinge axis is particularly located near an inner edge of said joint part. In the alternative said hinge axis is located near an outer edge of said joint part, as described in European patent application no. 04103735.9 of the same Applicant. In the latter case said resilient tongue is forced in the outward position under the influence of a moment in case a force is exerted on the wiper blade in a direction away from the oscillating arm. Particularly, the counterforce exerted by the oscillating arm on the resilient tongue engages at a point located behind the hinge axis, seen in the direction of the force exerted on the wiper blade. In other words, said moment of force ensures in a natural way that the resilient tongue is forced automatically in its outward position, that is its position retaining the wiper blade onto the oscillating arm. On the contrary, in the above-mentioned European patent publication no. 1 403 156 of the same Applicant said moment during use compels the resilient tongue to automatically take its inward position, thereby releasing the wiper blade from the oscillating arm, with all negative consequences involved.

In another preferred embodiment of a windscreen wiper device in accordance with the invention the oscillating arm has an at least substantially U-shaped cross-section at the location of its connection to said joint part, wherein said hole is provided in a base of said U-shaped cross-section. In addition thereto or in the alternative said joint part comprises at least two lateral resilient tongues extending outwardly, wherein the oscillating arm has an at least substantially U-shaped cross-section at the location of its connection to said joint part, and wherein each tongue engages in a correspondingly shaped hole provided in a leg of said U-shaped cross-section.

In another preferred embodiment of a windscreen wiper device according to the invention said hole(s) has/have a closed circumference. Such (a) closed hole(s) enhance(s) the retention of the connection device/joint part onto the oscillating arm in all possible directions, particularly both horizontally and vertically. In the alternative, said hole(s) has/have a non-closed circumference.

In another preferred embodiment of a windscreen wiper device in accordance with the invention said joint part is made of plastic (including any synthetic material having some flexibility).

In another preferred embodiment of a windscreen wiper device according to the invention said joint part is pivotally connected to said connecting device, wherein said protrusions of said connecting device pivotally engage in said recesses of said joint part, wherein said joint part has an at least substantially U-shaped cross-section at the location of its connection to said connecting device, and wherein said joint part comprises a recess in the base of the U-shaped cross-section for snappingly connecting said oscillating arm to said joint part. Particularly, a windscreen wiper device wherein a resilient free end of said joint part can pivot about a hinge axis for snappingly connecting said oscillating arm to said joint part.

In another preferred embodiment of a windscreen wiper device in accordance with the invention said resilient free end of said joint part can pivot about said hinge axis between a first position for mounting or dismounting a free end of said oscillating arm into or from said recess in the base of the U-shaped cross-section of said joint part, and a second position for connecting said free end of said of said oscillating arm to said joint part.

In another preferred embodiment of a windscreen wiper device according to the invention said joint part comprises at least one protrusion extending laterally from a longitudinal side of said joint part, said protrusion hooking behind a correspondingly shaped protrusion on said oscillating arm for blocking a longitudinal movement of said wiper blade with respect to said oscillating arm. In order to connect said oscillating arm to said joint part said oscillating arm is preferably pivoted relative to said joint part in an inclined position with respect to said wiper blade, so that said protrusion on said joint part is hooking behind said correspondingly shaped protrusion on said oscillating arm, wherein said oscillating arm is pivoted back relative to said joint part in a parallel position with respect to said wiper blade, so that a free end of said oscillating arm is snapped in said recess at the free end of said joint part.

In another preferred embodiment of a windscreen wiper device in accordance with the invention said connecting device is pivotally connected to said oscillating arm near its free end about a pivot axis of a transverse pivot pin provided on said oscillating arm, said pivot pin being inserted into said co-axial through holes of said protrusions of said connecting device. Particularly, said joint part has an at least substantially U-shaped cross-section at the location of its connection to said connecting device, wherein said joint part in each leg of said U-shaped cross-section is provided with a recess provided coaxially with said pivot axis, said recesses being co-axial, and wherein said pivot pin is inserted into said co-axial recesses and into said co-axial through holes of said protrusions of said connecting device.

The invention will now be explained in more detail with reference to figures illustrated in a drawing, wherein:

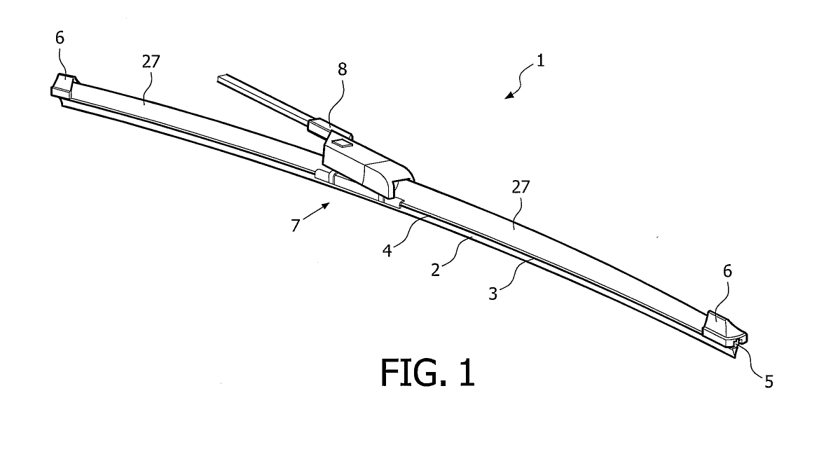

FIG. 1 is a perspective, schematic view of a preferred embodiment of a windscreen wiper device in accordance with the invention;

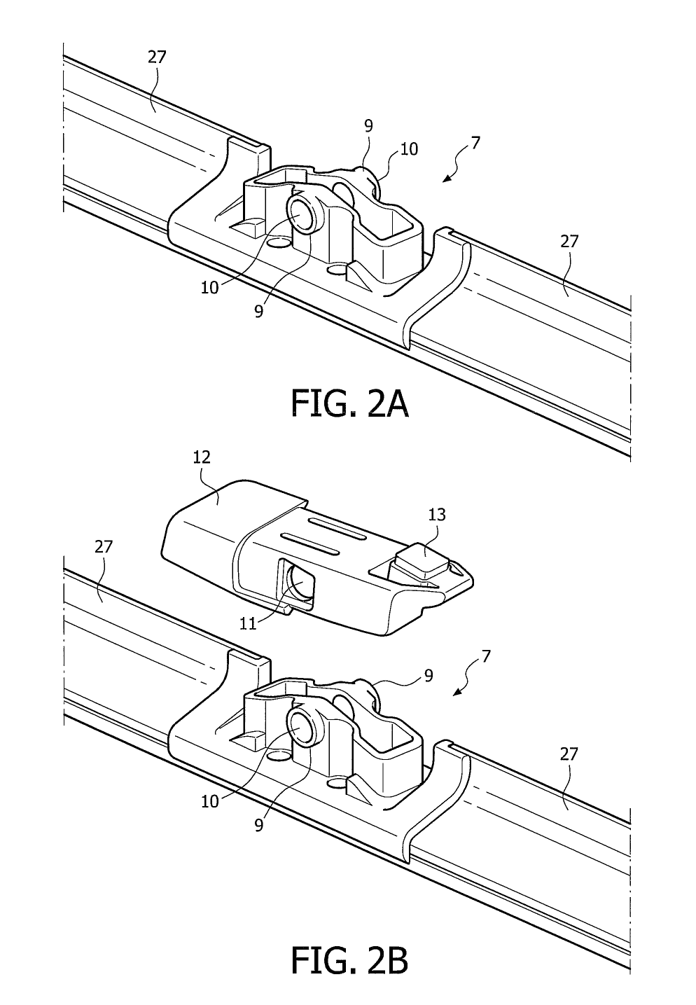

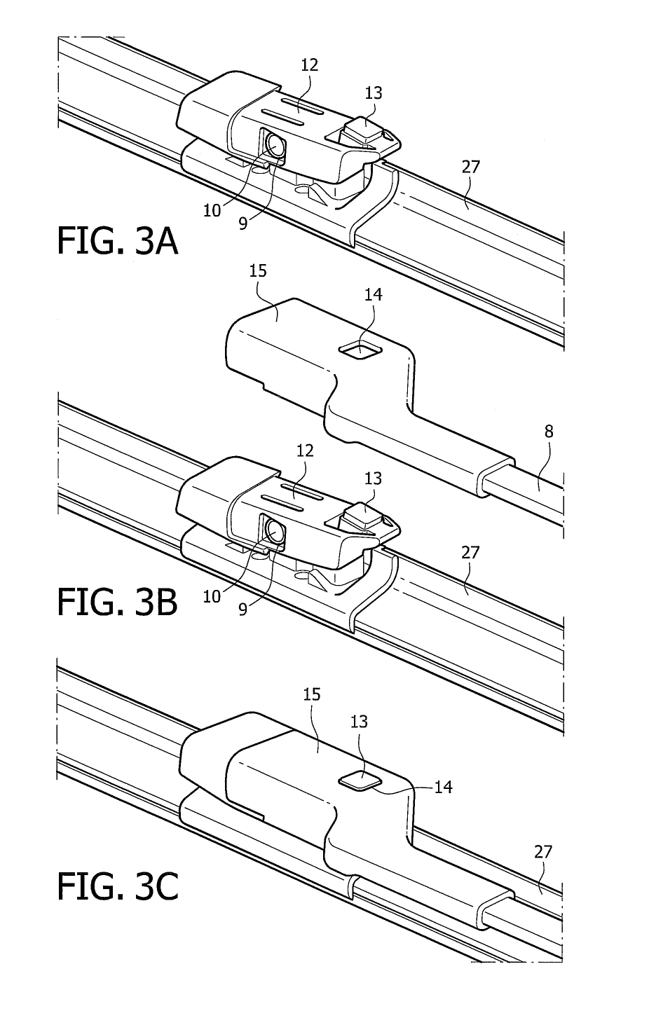

FIGS. 2 and 3 show various successive steps for fitting the connecting device, the joint part and the oscillating arm of FIG. 1 together; and

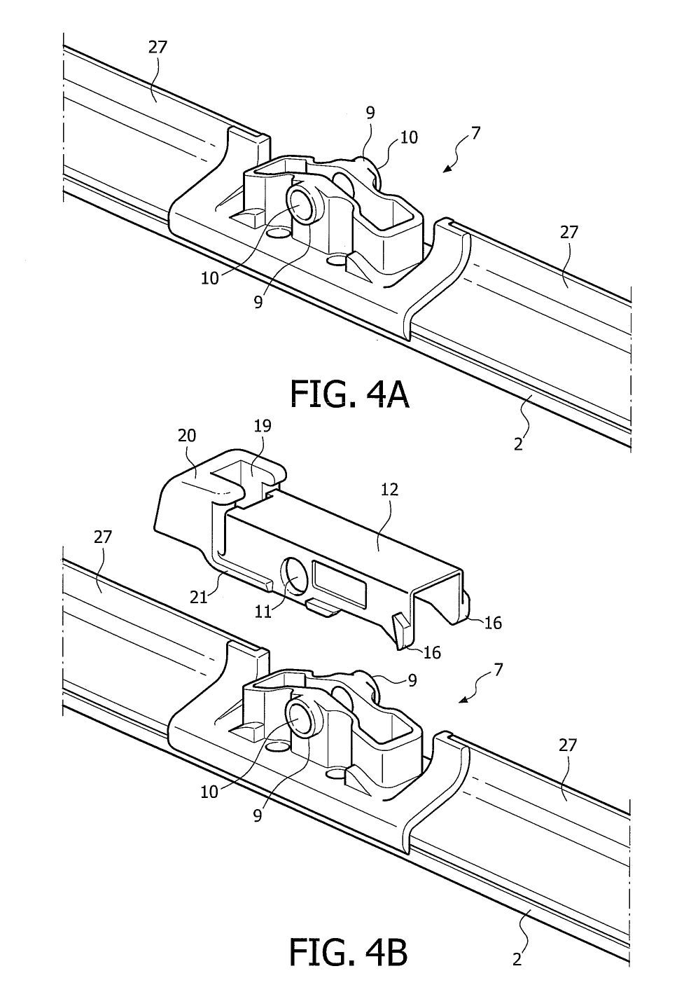

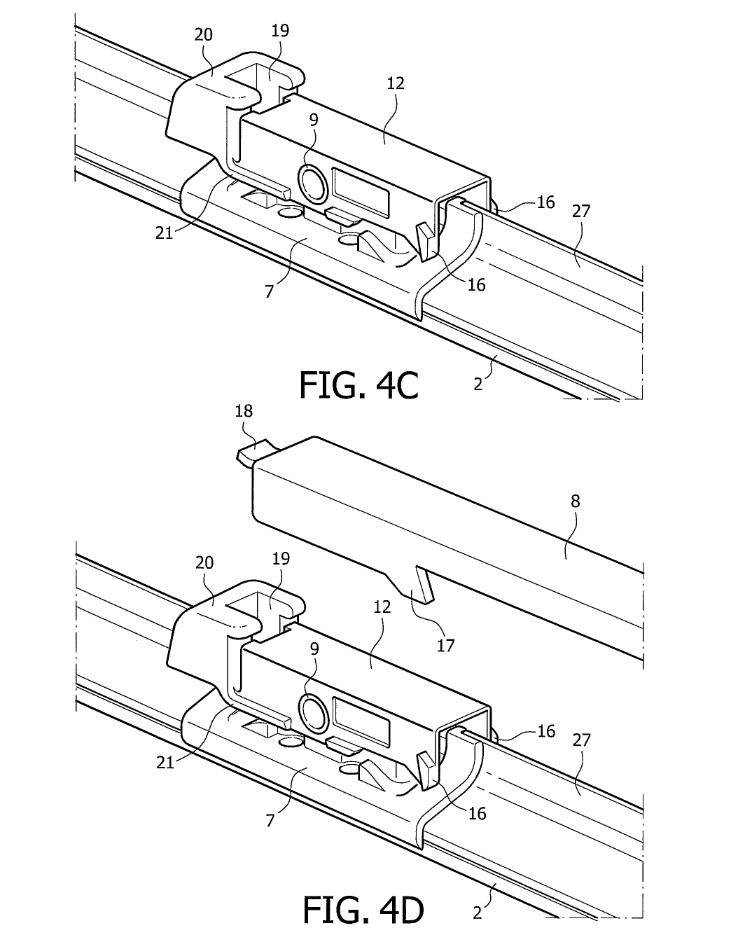

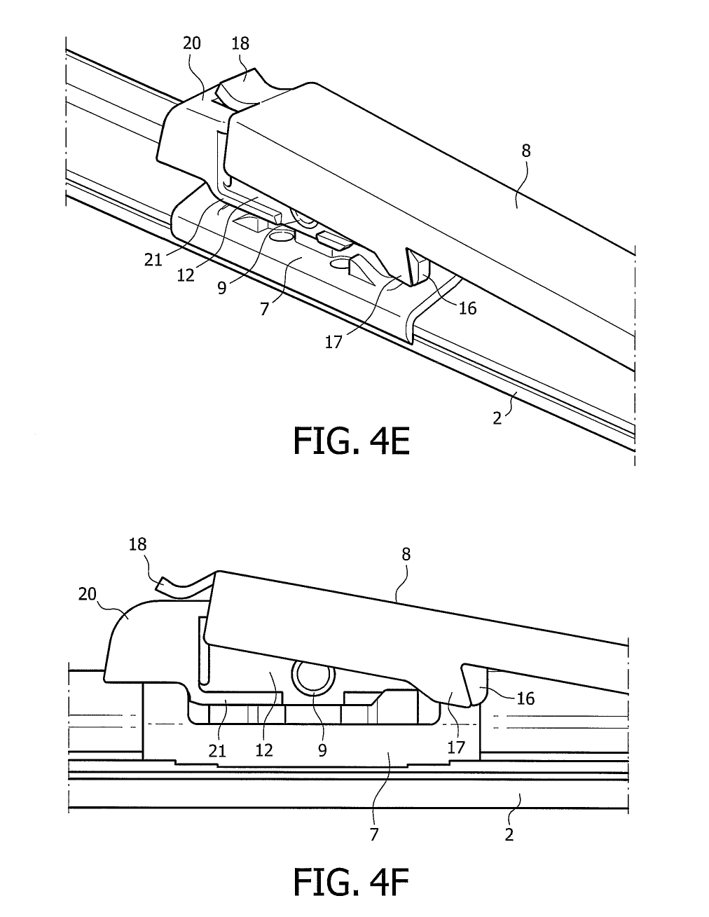

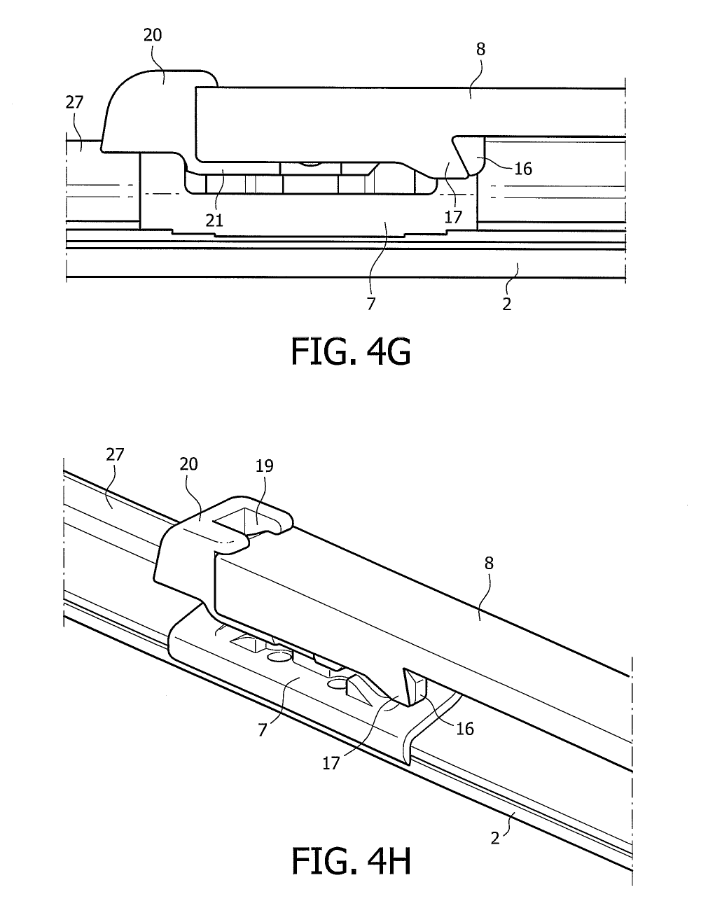

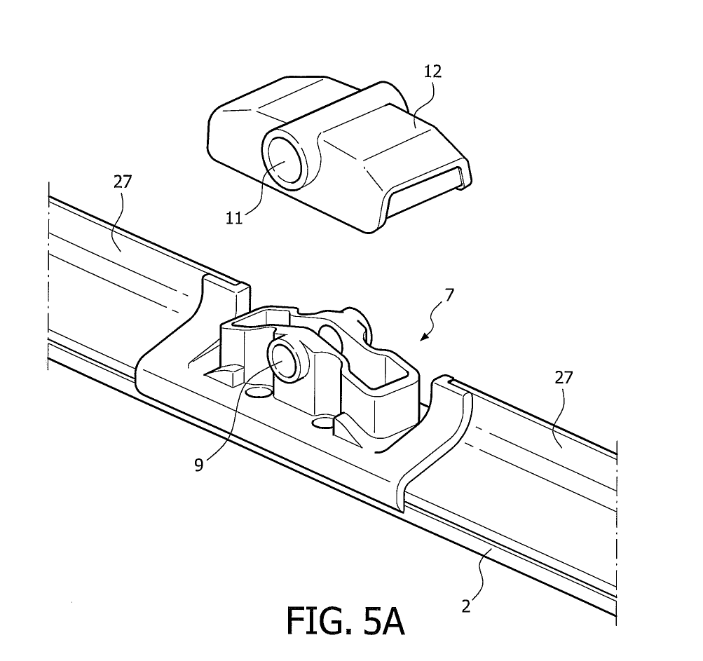

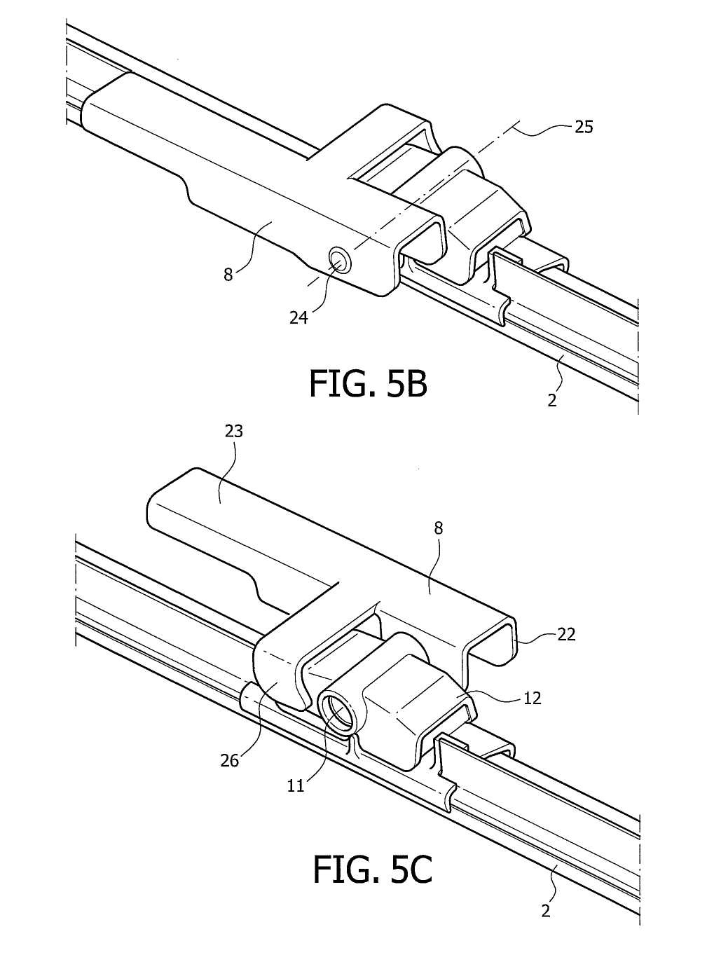

FIGS. 4 and 5 correspond to FIG. 3, but now relating to different types of joint parts and oscillating arms.

FIG. 1 shows a preferred variant of a windscreen wiper device 1 according to the invention. Said windscreen wiper device 1 is built up of an elastomeric wiper blade 2, in the longitudinal sides of which opposing longitudinal grooves 3 are formed, and of longitudinal strips 4 made of spring band steel, which are fitted in said longitudinal grooves 3. Said strips 4 form a flexible carrier element for the wiper blade 2, as it were, which is thus biassed in a curved position (the curvature in operative position being that of a windscreen to be wiped). Neighbouring ends 5 of the strips 4 are interconnected on either side of the windscreen wiper device 1 by means of connecting pieces 6 functioning as clamping members. In this embodiment, the connecting pieces 6 are separate constructional elements, which may be form-locked (“positive locking” or “having a positive fit”) or force-locked to the ends 5 of the strips 4. In another preferred embodiment, said connecting pieces 6 are in one piece with the strips 4 made of spring band steel. In the latter case said connecting pieces 6 form transverse bridges for the strips 4, as it were.

The windscreen wiper device 1 is furthermore built up of a connecting device 7 of plastic material for an oscillating arm 8. Alternatively, the connecting device 7 may also be made of metal, such as steel or aluminum. The connecting device 7 is particularly welded, brazed (“soldered”), glued or clamped onto said strips 4. The oscillating arm 8 is pivotally connected to said unit about a pivot axis near one end, as will be described hereunder. The connecting device 7 is a universal part in the sense that it can be used for each and every type of interconnection between the wiper blade 2 and the oscillating arm 8, that is, for example, for said interconnection as shown is FIGS. 2, 3 and 4, respectively.

With reference to FIG. 2A the connecting device 7 comprises two cylindrical protrusions 9 extending outwards on either side of said connecting device 7, said protrusions 9 having co-axial through holes 10. Alternatively, said protrusions 9 may have a spherical or frusto-conical shape. These protrusions 9 pivotally engage in identically shaped cylindrical recesses 11 of a plastic joint part 12 (FIG. 2B). In the alternative the recesses 11 may have a non-closed shape (i.e. open circumference). Said protrusions 9 act as bearing surfaces at the location of a pivot axis in order to pivot the joint part 12 (and the oscillating arm 8 attached thereto) about said pivot axis near one end of the oscillating arm 8. The protrusions 9 are preferably in one piece with the connecting device 7.

With reference to FIGS. 2B and 3, the joint part 12 comprises one resilient tongue 13 extending outwardly, while the oscillating arm 8 has an U-shaped cross-section at the location of its connection to said joint part 12, so that the tongue 13 engages in an identically shaped hole 14 provided in a base 15 of said U-shaped cross-section (FIG. 3B). The joint part 12 being already clipped onto the connecting device 7 is pivoted relative to said connecting device 7, so that said joint part 12 can be easily slid on a free end of the oscillating arm 8. During this sliding movement the resilient tongue 13 is initially pushed in against a spring force and then allowed to spring back into said hole 14, thus snapping, that is clipping the resilient tongue 13 into the hole 14 (FIG. 3C). This is a so-called bayonet-connection. The oscillating arm 8 together with the joint part 12 may then be pivoted back in a position parallel to the wiper blade 2 in order to be ready for use. By subsequently pushing in again said resilient tongue 13 against the spring force (as if it were a push button), the connecting device 7 and the joint part 2 together with the wiper blade 2 may be released from the oscillating arm 8. Dismounting the connecting device 7 with the wiper blade 2 from the oscillating arm 8 is thus realized by sliding the connecting device 7 and the joint part 2 together with the wiper blade 2 in a direction away from the oscillating arm 8.

FIGS. 4 and 5 correspond to FIG. 3, but now relating to a different type of joint part 12 and a different type of oscillating arm, wherein corresponding parts have been designated with the same reference numerals. A connecting device 7 as shown in FIGS. 4 and 5 is identical to the same of FIG. 2, so that said connecting device 7 is a true universal part for several types of interconnection between a wiper blade 2 and an oscillating arm 8. Actually, the embodiments of FIGS. 3 through 5 basically differ in the way the oscillating arm 8 is pivotally connected to said joint part 12. While in the embodiment of FIG. 3 a so-called bayonet-connection is used for detachably connecting said oscillating arm 8 to said joint part 12, in the embodiment of FIG. 4 a snap connection is applied for detachably connecting said oscillating arm 8 to said joint part 12, while in FIG. 5 a side connection is used for that purpose.

FIG. 4 shows the steps of mounting the wiper blade 2 onto the oscillating arm 8. Starting with the connecting device 7 being fixedly connected by gluing onto the strips 4 of the wiper blade 2 (FIG. 4A), the joint part 12 is first clipped onto the connecting device 7 (FIGS. 4B and 4C), while said oscillating arm 8 is subsequently pivoted relative to said joint part 12 in an inclined position with respect to said wiper blade 2, so that protrusions 16 each extending sidewards from a longitudinal side of said joint part 12 are hooking behind correspondingly shaped protrusion 17 on said oscillating arm 8 (FIGS. 4D and 4E). As can be seen from FIG. 4D, said oscillating arm 8 has an U-shaped cross-section at the location of its connection to said joint part 12, whereas said protrusions 17 each extend downwards from a leg of said U-shaped cross-section. Finally, said oscillating arm 8 may then be pivoted back relative to said joint part 12 in a position parallel to the wiper blade 2 (FIG. 2F). As a consequence thereof a top surface of said free end of said oscillating arm 8 together with a stiff finger 18 will be clipped/snapped in a recess 19 at a free end 20 of said joint part 12, so that the present windscreen wiper device 1 is ready for use (FIGS. 4G and 4H). By a reciprocal movement the wiper blade 2 can be released from the oscillating arm 8. Said snapping movement is realized, as said free end 20 of said joint part 12 is made resiliently, so that it can pivot about a hinge axis 21 (FIG. 4F).

In the embodiment of FIG. 5 the free end of the oscillating arm 8 has a U-shaped cross-section, wherein legs 22 of the U-shaped cross-section are orientated towards a windscreen to be wiped and wherein a base 23 of the U-shaped cross-section is orientated parallel to a windscreen to be wiped. Between the legs 22 of the U-shaped cross-section and protruding in a direction towards the wiper blade 2 is a joint pin or pivot pin 24 whose pivot axis 25 extends in a direction of the oscillating movement of the oscillating arm 8. The diameter of the pivot pin 24 is adapted to the diameter of the bearing bores or through holes 10 in said connecting device 7 and to the diameter of the recesses 11 of said joint part 12, said through holes 10 and said recesses 11 being co-axial. In order to secure or retain the connecting device 7 (and thus the wiper blade 2) onto the ocillating arm 8 said oscillating arm 8 is provided with an extension comprising said pivot pin 24 and a L-shaped shoulder 26 which projects out in the direction of said pivot pin 24 and across said wiper blade 2 and at the free end of which is disposed a leg facing the windscreen.

Possibly, a spoiler 27 is furthermore present being made in one piece with said wiper blade 2.

The invention is not restricted to the variants shown in the drawing, but it also extends to other embodiments that fall within the scope of the appended claims.

1. A windscreen wiper device comprising an elastic, elongated carrier element, as well as an elongated wiper blade of a flexible material, which can be placed in abutment with a windscreen to be wiped, which wiper blade includes opposing longitudinal grooves on its longitudinal sides, in which grooves spaced-apart longitudinal strips of the carrier element are disposed, wherein neighbouring ends of said longitudinal strips are interconnected by a respective connecting piece, which windscreen wiper device comprises a connecting device for an oscillating arm, wherein said oscillating arm is pivotally connected to said connecting device about a pivot axis near one end, with the interposition of a joint part, said joint part being detachably connected to said connecting device by engaging protrusions of said connecting device, at the location of said pivot axis, in recesses provided in said joint part, and wherein said protrusions are provided with co-axial through holes.

2. A windscreen wiper device according to claim 1, wherein said joint part is detachably connected to said connecting device through a snapping/clipping operation.

3. A windscreen wiper device according to claim 1, wherein said joint part has an at least substantially U-shaped cross-section at the location of its connection to said connecting device, and wherein said joint part in each leg of said U-shaped cross-section is provided with a recess provided coaxially with said pivot axis.

4. A windscreen wiper device according to claim 1, wherein the protrusions extend outwards on either side of said connecting device, and wherein the protrusions and their co-axial through holes are at least substantially cylindrical.

5. A windscreen wiper device according to claim 1, wherein said joint part is pivotally connected to said connecting device, wherein said protrusions of said connecting device pivotally engage in said recesses of said joint part, wherein said joint part comprises at least one resilient tongue engaging in a correspondingly shaped hole provided in said oscillating arm, and wherein said resilient tongue is rotatable along a hinge axis between an outward position retaining said wiper blade onto said oscillating arm and an inward position releasing said wiper blade from said oscillating arm.

6. A windscreen wiper device according to claim 5, wherein said hinge axis is located near an inner edge of said joint part.

7. A windscreen wiper device according to claim 5, wherein said hinge axis is located near an outer edge of said joint part.

8. A windscreen wiper device according to claim 5, wherein said oscillating arm has an at least substantially U-shaped cross-section at the location of its connection to said joint part, and wherein said hole is provided in a base of said U-shaped cross-section.

9. A windscreen wiper device according to claim 5, wherein said joint part comprises at least two lateral resilient tongues extending outwardly, wherein said oscillating arm has an at least substantially U-shaped cross-section at the location of its connection to said joint part, and wherein each tongue engages in a correspondingly shaped hole provided in a leg of said U-shaped cross-section.

10. A windscreen wiper device according to claim 5, wherein said hole(s) has/have a closed circumference.

11. A windscreen wiper device according to claim 1, wherein said joint part is pivotally connected to said connecting device, wherein said protrusions of said connecting device pivotally engage in said recesses of said joint part, wherein said joint part has an at least substantially U-shaped cross-section at the location of its connection to said connecting device, and wherein said joint part comprises a recess in the base of the U-shaped cross-section for snappingly connecting said oscillating arm to said joint part.

12. A windscreen wiper device according to claim 11, wherein a resilient free end of said joint part can pivot about a hinge axis for snappingly connecting said oscillating arm to said joint part.

13. A windscreen wiper device according to claim 12, wherein said resilient free end of said joint part can pivot about said hinge axis between a first position for mounting or dismounting a free end of said oscillating arm into or from said recess in the base of the U-shaped cross-section of said joint part, and a second position for connecting said free end of said of said oscillating arm to said joint part.

14. A windscreen wiper device according to claim 11, wherein said joint part comprises at least one protrusion extending laterally from a longitudinal side of said joint part, said protrusion hooking behind a correspondingly shaped protrusion on said oscillating arm for blocking a longitudinal movement of said wiper blade with respect to said oscillating arm.

15. A windscreen wiper device according to claim 14, wherein for connecting said oscillating arm to said joint part said oscillating arm is pivoted relative to said joint part in an inclined position with respect to said wiper blade, so that said protrusion on said joint part is hooking behind said correspondingly shaped protrusion on said oscillating arm, and wherein said oscillating arm is pivoted back relative to said joint part in a parallel position with respect to said wiper blade, so that a free end of said oscillating arm is snapped in said recess at the free end of said joint part.

16. A windscreen wiper device according to claim 1, wherein said connecting device is pivotally connected to said oscillating arm near its free end about a pivot axis of a transverse pivot pin provided on said oscillating arm, said pivot pin being inserted into said co-axial through holes of said protrusions of said connecting device.

17. A windscreen wiper device according to claim 16, wherein said joint part has an at least substantially U-shaped cross-section at the location of its connection to said connecting device, wherein said joint part in each leg of said U-shaped cross-section is provided with a recess provided coaxially with said pivot axis, said recesses being co-axial, and wherein said pivot pin is inserted into said co-axial recesses and into said co-axial through holes of said protrusions of said connecting device.

18. A windscreen wiper device comprising an elongated elastic carrier element self-biased to a curved shape; a flexible wiper blade operatively supported by said carrier and biased thereby to a curved shape; a connecting device secured to said carrier for operative connection with a wiper arm; a joint part detachably pivotally connected to said connecting device by engaging protrusions of said connecting device at a location of a pivot axis of said joint part, said protrusions extending into recesses of said joint part, and wherein said protrusion are provided with co-axial through holes.
